(19) United States
(12) Patent Application Publication
(10) Pub. No.: US 2005/0263192 A1
(43) Pub. Date: Dec. 1, 2005

(54) Tap for a gas or liquefied gas cylinder

(76) Inventor: Paul Kremer, Walferdange (LU)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/137,311

(22) Filed: May 24, 2005

(30) Foreign Application Priority Data
May 26, 2004 (EP) 04102322.7

(51) Int. Cl. F16K 37/00

(52) U.S. Cl. 137/556

(57) ABSTRACT

A tap for a gas or liquefied gas cylinder comprises a tap body having a tap stem and a closure element which are engaged directly in a tap body bore without the intermediary of a gland ring. A fixed seat of the tap is formed on a seat tube separate from the tap body. The tap stem, the closure element and the seat tube being adapted to be removably inserted into the tap body bore from the base end thereof.

### CROSS-REFERENCE TO RELATED APPLICATIONS

This application claims priority under 35 U.S.C. §119 to European App. No. 04102322.7 which was filed on May 26, 2004, and which is incorporated herein by reference.

### STATEMENT REGARDING FEDERALLY SPONSORED RESEARCH OR DEVELOPMENT

Not Applicable.

### BACKGROUND OF THE INVENTION

The present invention relates to tap for a gas or liquefied gas cylinder comprising a tap body, a fixed seat, a movable closure element for opening or closing the tap and a tap stem for moving the closure element between the closed position and the open position.

A tap of this type is well known in the prior art. Taps of this type normally have a fixed seat formed in one single piece with the tap body. The tap stem and the closure element are normally assembled into the tap body from the head end thereof and an annular plug or a gland ring is usually provided between the tap stem and the tap body thereby forming at least two annular interfacial boundaries, namely a first between the plug and the stem and a second between the plug and the tap body, which must be sealed to avoid gas leakage at the head end of the tap body.

### BRIEF SUMMARY OF THE INVENTION

The object of the invention is to provide an improved tap, of simplified construction, which does not have the disadvantages referred to above.

To this effect there is provided in accordance with the invention a tap for a gas or liquefied gas cylinder, comprising:
a tap body having a main portion and a base end portion, said tap body defining a base end and a head end at the opposite ends of the tap body, and said tap body having a longitudinal bore extending therethrough and opening out at the base end and at the head end of the tap body;
a movable tap stem-closure element assembly tightly mounted within the longitudinal bore and movable to open and close the tap, said tap stem-closure element assembly being supported within the longitudinal bore solely by the tap body which surrounds said movable assembly directly so as to provide only one single annular interfacial boundary to be sealed to prevent gas leakage at the head end of the tap body;
wherein said longitudinal bore has a sufficient diameter so that the tap stem-closure element assembly is adapted to be installed into the longitudinal bore through the base end portion of the tap body; and said tap further comprising
a fixed seat formed on a seat element that is separate from the tap body and adapted to be installed into the longitudinal bore through the base end portion of the tap body.

Preferably, the seal element is an elongated replaceable seat tube threaded into the longitudinal bore and the seat tube has an enlarged head accessible at the base end of the tap body to permit tightening and unscrewing of the seat tube.

According to another advantage of the invention a safety valve mounted in the tap body may communicate with the exterior of the tap at the base end thereof by means of an annular gas passage formed within the longitudinal bore between the seat tube and the tap body. Accordingly, there is no longer a need to provide in the base end portion of the tap body in addition to the normal gas flow passage another passage leading to the safety valve.

In order to retain the movable assembly within the longitudinal bore a first radial abutment surface facing axially towards the seat is formed between two portions of different diameter of the longitudinal bore, and a second radial counter-abutment surface is formed on the movable assembly between the first radial abutment surface and the seat element, this second radial counter-abutment surface facing towards the first radial abutment surface.

Several embodiments of the movable assembly are possible. It may be threaded into one or the other of two different diameter portions of the longitudinal bore and also received with a sliding fit into the one or the other of these two portions of different diameter. Moreover, the movable assembly comprising the tap stem and the closure element may also be formed in one single piece or in two different pieces coupled together and movable axially or rotationally one with respect to the other.

Preferably, the closure element of the movable assembly is a piece that is separate from the tap stem, the two pieces being integrally connected for rotation with one another but the closure element is displaceable axially with respect to the tap stem and the closure element is threaded into the larger diameter portion of the longitudinal bore whereas the tap stem is received with a sliding fit in the two portions of different diameter of the longitudinal bore.

The closure element may be threaded into the same threaded portion of the longitudinal bore as the seat tube.

Another object of the invention is to provide a tap with a simple and effective device to indicate the open or closed position of the tap.

According to the invention this object is achieved by a tap for a gas or liquefied gas cylinder comprising a tap body, a tap stem-closure element assembly movable between a closed position and an open position, and an annular element joined to the tap stem for rotation therewith and disposed exteriorly of the tap body, and an external ring disposed about the tap body and retained against rotation with respect thereto, said ring being mounted by a helical engagement means on the exterior of the annular element so that the ring effectuates an axial telescoping motion with respect to the annular element and the tap body in response to rotational movement of the tap stem and the annular element to cover or uncover a means for signaling the open position or the closed position of the tap.

The signaling means is stationary with respect to the tap body and may be a simple colored band applied directly to the tap or to any other appropriate part fixed thereto so as to be covered by the ring member when the tap is in open position or exposed when the tap is in the closed position. Alternatively the signaling means may also be formed by the annular element joined in rotation with the tap stem. This annular element is concealed by the ring member when the tap is in the closed position and partly exposed when the tap is in the open position. If this annular element serves as the signaling it will have a signaling color which distinguishes from the adjoining elements of the tap.

Preferably, the ring member is provided with an internal thread engaged with an external thread of the annular element joined in rotation with the tap stem and so as to produce a substantial axial movement of the ring member the pitch of the threaded engagement between the ring member and the annular element may be higher than the pitch of the thread of the tap body wherein the movable assembly is threadably engaged.

To complete the construction of the tap an actuating wheel is fixed to the tap stem for rotation therewith. Preferably, this actuating wheel is a member separate from the annular element and a weakening groove is formed in the tap stem at the boundary between the actuating wheel and the annular element. If a torsional force, or other force, exceeding a predetermined limit is applied to the actuating wheel, the tap stem will be torqued-off or sheared-off at the location of the weakening groove and the tap remains operational and may be opened or closed by manipulation of the annular element.

### BRIEF DESCRIPTION OF THE SEVERAL VIEWS OF THE DRAWINGS

The invention will now be explained in greater detail with reference to the annexed drawings, wherein:

FIG. 1 shows the tap according to the invention in open position,

FIG. 2 shows the tap of the invention in closed position,

FIG. 3 shows the lower portion of the tap of FIGS. 1 and 2, in longitudinal section in a plane oriented 90° with respect to the plane of the drawing of FIG. 1, and

FIG. 4 is a transverse sectional view along lines 4-4 of FIG. 2.

### DETAILED DESCRIPTION OF THE INVENTION

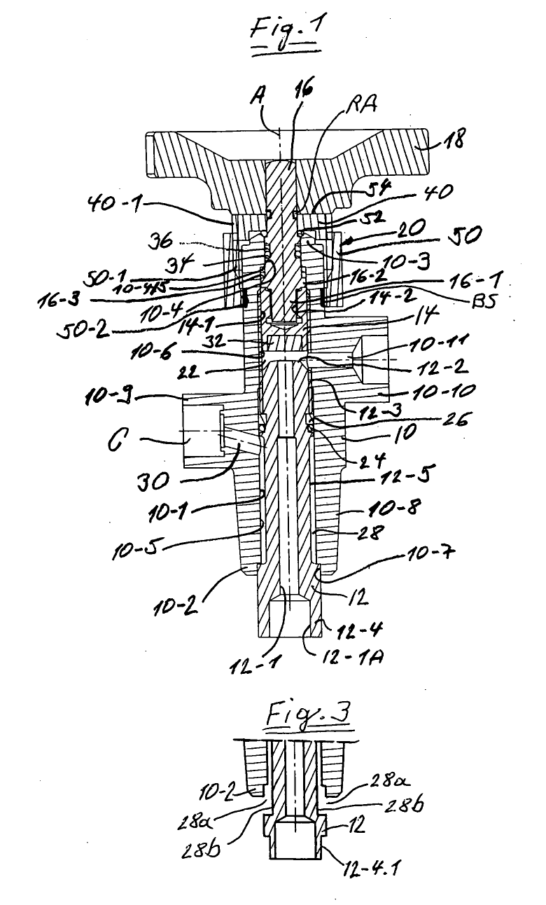

Referring now to FIGS. 1 and 2, which show the tap in upright position and in longitudinal section, it can be seen that the tap comprises a tap body 10, an elongated fixed seat tube 12, a movable closure element 14, a tap stem 16, an actuating wheel 18 and a position indicating device 20.

The tap body 10 has a main portion and a base end portion which are preferably formed in one single piece. The tap 10 further has a longitudinal axis A and a longitudinal central bore 10-1 extending completely through the body 10 from one end to the other end thereof, namely from the base end 10-2 to the head end 10-3 and opening out at these two extremities of the tap body 10. The longitudinal bore 10-1 is provided in proximity of the head end 10-3 of the body 10 with a reduced diameter portion 10-4 which is relatively short in axial direction with respect to the total length of the longitudinal bore 10-1. The major portion 10-5 of the longitudinal bore 10-1 extending from the reduced diameter portion 10-4 to the base end 10-2 of the tap body 10 has a larger diameter than the reduced diameter portion 104. The major portion 10-5 of larger diameter of the longitudinal bore 10-1 is provided with an internal thread 10-6. Between the internal thread 10-6 and the reduced diameter portion 10-4, the diameter of the longitudinal bore 10-1 is generally constant and preferably slightly smaller than the internal diameter of the thread 10-6; and between the thread 10-6 and a counter bore 10-7 at the base end 10-2, the diameter of the longitudinal bore 10-1 is generally constant and preferably slightly larger than the base diameter of the thread 10-6. A radial abutment surface 10-4/5 oriented axially in a direction towards the base end 10-2 or towards the seat tube 12 is formed between the two portions 10-4 and 10-5 of different diameter of the longitudinal bore 10-1.

The tap body 10 is also provided at its base end 10-2 with an external conical thread 10-8 forming the base end portion of the tap body 10 for connection to a gas or liquefied gas container (not shown). For another application this thread may have a cylindrical form. The base end portion is preferably formed integrally in one piece with the tap body.

The tap body 10 has on its left side (with reference to the drawings) a cylindrical socket 10-9 extending laterally and provided with a cavity C to receive therein a safety valve (not shown). On the right side of the tap body (again, with reference to the drawings) another cylindrical socket 10-10 is provided extending laterally and to which a gas consumer device (not shown) or a filling device (not shown) can be connected. The two sleeves 10-9 and 10-10 are each provided with an external thread (not shown).

Disposed within the longitudinal bore 10-1 and aligned with the longitudinal axis A are the seat tube 12, the closure element 14 and the tap stem 16. A valve chamber 22 is delimited within the longitudinal bore 10-1 between the seat tube 12 and the movable closure element 14. The seat tube 12 is traversed from its lower end up to its upper end by a gas flow passage 12-1 which is in communication with the valve chamber 22 in the open position of the tap. Another gas passage 10-11 is provided in the tap body 10 and this passage 10-11 is in communication with the valve chamber 22 and opens out at the free end of the socket 10-10 of the tap body 10.

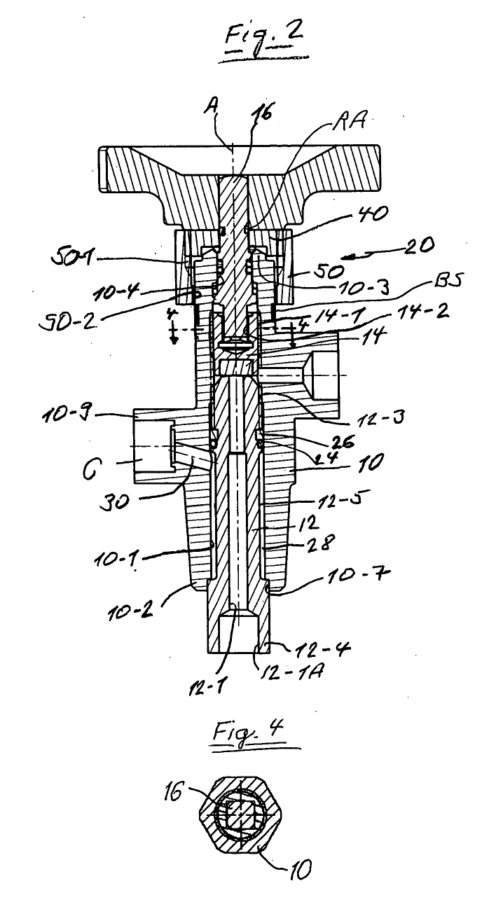

The seat tube 12 is separate from the tap body 10 and is disposed within the bore 10-1 and is provided at its upper end with a fixed seat 12-2 surrounding the gas passage 12-1. The seat tube 12 is provided with an external thread 12-3 proximate its upper end and is threaded into the thread 10-6 of the longitudinal bore 10-1. At its other end, namely at the lower end, the seat tube 12 is provided with an enlarged head 12-4 which is engaged in the counter-bore 10-7 and which is in engagement with the bottom surface of the counter-bore when the seat tube 12 is fully engaged and tightened in the bore 10-1 of the tap body 10. The head 12-4 is provided on its opposite sides with two flattened parallel surfaces 12-4.1 (see FIG. 3) to permit application of an appropriate tightening tool). To this effect, the major portion of the head 12-4 remains exposed below the tap body base end at the exterior of the counter-bore 10-7 when the seat tube 12 is assembled in the tap body 10.

The seat tube 12 is furthermore provided with a seal ring 24 disposed in an outer circumferential groove of the tube 12 to prevent gas leakage between the tube 12 and the tap body 10. Adjacent the seal ring 24 and also engaged within a groove of the tube 12 there is provided a support ring 26 for the seal ring 24. Between the groove of the seal ring 24 and the enlarged head 12-4 the seat tube 12 is provided with an elongated reduced diameter portion 12-5. This reduced diameter portion 12-5 and the internal surface of the longitudinal bore 10-1 delimiting an annular gas passage 28 which, at the base end 12-2, is in communication with the exterior of the tap by orifices 28a formed by the flattened parallel surfaces 28b (shown in FIG. 3) of the enlarged head 12-4. At its upper end the annular passage 28 is in communication by an inclined passage 30 with the cavity C for the safety valve (not shown).

The gas passage 12-1 is provided at its lower end in the enlarged head 12-4 with a threaded counter-bore 12-1A to permit connection of a plunger tube (not shown) thereto.

The movable closure element 14 is provided with an external thread 14-1 which is threaded into the thread 10-6 of the longitudinal bore 10-1 above the seat tube 12. The movable closure element is provided with a seal means 32 which is in tight engagement with the fixed seat 12-2 in the closed position of the tap. The movable closure element 14 is also provided at its other end with an axial cavity 14-2 which is non-circular in transverse cross-section, preferably square-shaped, to receive therein an axial projection 16-1 of corresponding shape of the tap stem 16. The tap stem 16 extends upwardly to the exterior of the tap body 10 and it is received in rotation by means of a sliding fit in the reduced diameter portion 10-4 of the longitudinal bore 10-1. Disposed within a groove of a tap stem 16 are a seal ring 34 and its support ring 36 to prevent gas leakage between the stem 16 and the tap body 10.

The tap stem is furthermore provided with a collar 16-2 forming a radial bearing disposed axially between the projection 16-1 and the groove of the sealing ring 34 and which is engaged within the longitudinal bore 10-1 between the axial abutment 10-4/5 of the longitudinal bore 10-1 and the upper end of the thread 10-6 of the longitudinal bore 10-1. The collar 16-2 has an external diameter slightly larger than the diameter of the reduced diameter portion 104 and approximately equal to the diameter of the main portion 10-5 of the longitudinal bore 10-1 above the thread 10-6. The collar 16-2 is received with a sliding fit within the larger diameter portion 10-5 of the longitudinal bore 10-1. The collar 16-2 is provided at its upper end with an radial counter-abutment surface 16-3 oriented axially towards the abutment surface 10-4/5 and cooperating therewith to retain the tap stem 16 within the longitudinal bore 10-1.

To assemble the tap, the tap stem 16 and the movable closure element 14 are first installed within the tap body 10 by threading the movable closure element 14 from the base end into the thread 10-6 of the longitudinal bore 10-1. During this assembly the tap stem 16 is received within the reduced diameter portion 10-4 and a portion of the stem 16 extends upwardly from the tap body 10 beyond the end of the head 10-3 thereof. The tap stem 16 is lodged for rotation directly and exclusively within the reduced diameter portion 10-4 and the larger diameter portion 10-5 of the bore 10-1. Accordingly, a gland ring is no longer necessary between the stem 16 and the tap body 10. The tap stem 16 is retained in position by the abutment 10-4/5 formed between the portions 10-4 and 10-5 of the bore 10-1 in cooperation with the counter-abutment 16-3 of the collar 16-2. As the tap stem 16 and the closure element 14 are supported from the tap body 10 which directly surrounds the same, the tap comprises only one single annular interfacial boundary to be sealed off to prevent leakage of gas at the head end of the tap body 10.

Thereafter, the seat tube 12 is also introduced through the base end 10-2 and its external thread 12-3 is threaded into the internal thread 10-6 of the longitudinal bore 10-1. The seat tube 12 is tightened by application of a predetermined torsional force to the head portion 12-4 so that the head portion 12-4 is firmly engaged against the bottom of the counter bore 10-7.

To open or close the tap, the stem 16 is rotated by means of the actuating wheel 18. The stem does not move in vertical direction but its movement of rotation is transmitted to the closure element 14 which due to its threaded engagement in the bore 10-1 is axially displaced for opening or closing the tap.

As an alternative of the embodiment which has been described hereinbefore and which is shown in FIGS. 1 and 2, the tap stem may also have an externally threaded portion threaded into an internal thread of the reduced diameter portion 10-4; and the movable closure element 14 may be guided by a sliding fit in the longitudinal bore 10-1 instead of the threaded engagement shown in FIGS. 1 and 2. In this case the stem 16 is vertically movable when the tap is opened and closed; and this vertical movement is transmitted to the movable closure element by a connector coupling the stem and the closure element for common axial movement, but permitting a rotation of the stem with respect to the closure element instead of the connector formed by the square-shaped cavity 14-2 and the projection 16-1 permitting a relative axial movement between the stem 16 and the closure element 14 but coupling the stem 16 and the closure element 14 for rotation one with the other.

According to yet another embodiment the tap stem 16 and the closure element 14 may be formed of one single vertically movable part, which may be rotatable or non-rotatable. The sole rotatable part constituting the tap stem 16 and the closure element 14 may also have an external thread engaged with an internal thread of the longitudinal bore.

In all of these cases the seat tube 12 and the movable assembly comprising the tap stem 16 and the closure element 14 may be assembled within that tap body 10 from the base end 10-2 and the movable assembly is supported directly and solely within the longitudinal bore 10-1 without the intermediary of a gland ring or a plug between the tap stem 16 and the tap body 10.

Furthermore, the longitudinal bore may have two threaded portions of different diameters, namely a first threaded portion for the movable closure element 14 and a second threaded portion of larger diameter for the seat tube 12.

The position indicating device 12 of the present invention will now be explained in greater detail with reference to FIGS. 1 and 2.

The position indicating device comprises an annular element 40 joined to the tap stem 16 for rotation therewith above the head end 10-3 of the tap body 10. An external ring 50 is disposed about the tap body 10 at the head end thereof and is retained against rotation with respect to the tap body 10. The ring 50 is provided with an appropriate helical engagement means, preferably an internal thread 50-1, threaded onto an external thread 40-1 of the annular element 40. At its lower end the external ring 50 has a polygonal portion 50-2, preferably hexagonal, which surrounds a portion of corresponding shape (see FIG. 4) at the head end 10-3 of the tap body 10. Accordingly, the ring 50 is prevented from rotating with respect to the tap body 10; and when the stem 16 is rotated in one or the other direction the ring 50 effectuates an axial movement in one or the other direction along the longitudinal axis A and is displaced telescopically on the annular element 40 and the tap body 10.

In one embodiment a signaling band BS, of a easily discernable color, such as a red or green color, is applied to the external surface of the head portion 10-3 of the tap body 10 in a appropriate position so as to be concealed by the ring 50 when the tap is in an open position and so as to be exposed and easily discernable below the ring 50 when the tap is closed. Alternatively, instead of this signaling band BS, the annular element 40 may be the signaling means and may indicate the open position, shown in FIG. 1, wherein a portion of the annular element 40 is exposed upwardly of the ring 50, or the closed position, shown in FIG. 2, wherein the annular element 40 is totally concealed by the ring 50. If the annular element 40 serves as the signaling means, it has preferably an easily discernable color, red or green, so as to be distinguished from the adjoining parts of the tap.

Preferably, the pitch of the engaging threads of the member 40 and the ring 50 is larger than the pitch of the engaging threads of the movable closure element 14 and the longitudinal bore 10-1 of the tap body 10 to obtain a larger vertical movement of the ring 50 than the vertical movement of the closure element 14. This position indicator is appropriate for any tap having a rotatable actuation sleeve but preferably non-displaceable in axial direction.

A sealing ring 52 is preferably provided between the annular element 40, the upper end 10-3 of the tap body 10 and the tap stem 16.

Above the annular element 40 the actuating wheel 18 is fixed to the tap stem 16 for joined rotation therewith. The actuating wheel 18 and the annular element 40 may be formed of one single piece, but preferably the two elements are separate parts having a common interface plane 54. The tap stem 16 is preferably provided with a weakening groove RA disposed approximately within the interface plane 54. This weakening groove (not shown) ensures shearing off of the tap stem 16 in the interface plane if a torsional force, or other force, exceeding a predetermined limit, is applied to the actuating wheel 18. By the shearing off of the tap stem 16 at the location of the weakening groove, namely at the exterior of the tap body 10 and at the upper end of the annular element 40, the advantage is obtained that the mechanism of the tap remains operational and the tap may be closed or opened by manipulation of the annular element 40 remaining coupled to the stem 16.

The invention is not limited to the particular embodiments which have been described hereinbefore in detail, but to the contrary, many modifications and variations may be applied thereto by the skilled person without leaving the scope of the annexed claims.

1. A tap for a gas or liquefied gas cylinder, comprising:
a tap body defining a base end and a head end at the opposite ends of the tap body, and said tap body having a longitudinal bore extending therethrough and opening out at the base end and at the head end of the tap body;
a movable tap stem-closure element assembly tightly mounted within the tap body longitudinal bore and movable to open and close the tap, said tap stem-closure element assembly being supported within the longitudinal bore solely by the tap body which surrounds said movable assembly directly so as to provide only one single annular interfacial boundary to be sealed to prevent gas leakage at the head end of the tap body;
wherein said longitudinal bore has a sufficient diameter so that the tap stem-closure element assembly is adapted to be installed into the longitudinal bore through the base end portion of the tap body; and said tap further comprising
a fixed seat formed on a seat element that is separate from the tap body and adapted to be installed into the longitudinal bore through the base end portion of the tap body.

2. The tap according to claim 1, wherein the seat element is an elongated replaceable seat tube threaded into the longitudinal bore.

3. The tap according to claim 2, wherein the seat tube has an enlarged head accessible at the base end of the tap body to permit tightening and unscrewing of the seat tube.

4. The tap according to claim 1, wherein a seal means is provided between the seat element and the tap body.

5. The tap according to claim 3, wherein an annular gas passage is formed between the seat tube and the tap body, said gas passage being in communication on one side with the exterior of the tap at the base end thereof and at another side with a cavity formed in the tap body and adapted to receive a safety valve.

6. The tap according to claim 5, wherein the annular passage is formed by a length of reduced diameter portion of the seat tube, the seat of the seat tube being formed to ensure communication between the annular passage and the exterior of the tap at the base end of the tap body.

7. The tap according to claim 1, wherein a first radial abutment surface facing axially towards the seat element is formed between two portions of different diameter of the longitudinal bore and a second radial counter-abutment surface is formed on the movable assembly between the first radial abutment surface and the seat element, said second radial counter-abutment surface facing oriented towards the first radial abutment surface so as to retain the movable assembly within the longitudinal bore.

8. The tap according to claim 7, wherein the movable assembly is received with a sliding fit in at least one of the two portions of different diameter of the longitudinal bore.

9. The tap according to claim 8, wherein the movable assembly is provided with an outer thread screwed into an inner thread of at least one of the two portions of different diameter of the longitudinal bore.

10. The tap according to claim 9, wherein the movable assembly is threadedly engaged in the larger diameter portion of the longitudinal bore.

11. The tap according to claim 10, wherein the larger diameter portion of the longitudinal bore comprises a single internal thread whereinto the movable element and the seat element are threadedly engaged.

12. The tap according to claim 9, wherein the movable assembly comprising the tap stem and the closure element is formed of one single piece.

13. The tap according to claim 10, wherein the closure element of the movable assembly is a member separate from the tap stem.

14. The tap according to claim 13, wherein the two members constituting the movable element are unitary in rotation with one another, but the closure element is displaceable axially with respect to the tap stem.

15. The tap according to claim 14, wherein the closure element is threadedly engaged in the portion of larger diameter of the different diameter portions of the longitudinal bore and the tap stem is received with a sliding fit in at least one of the two portions of different diameter of the longitudinal bore.

16. The tap according to claim 13, wherein the seat tube is threadedly engaged in the same internal thread of the longitudinal bore as the closure element.

17. The tap according to claim 13, wherein the closure element is coupled to the tap stem so as to be axially displaceable therewith while permitting rotation of the tap stem with respect to the closure element.

18. The tap according to claim 17, wherein the tap stem is provided with an external thread that is threadedly engaged into the portion of smaller diameter of the different diameter portions of the longitudinal bore and wherein the closure element is received with a sliding fit in the portion of large diameter of the different diameter portions of the longitudinal bore.

19. The tap according to claim 1, wherein a sealing means is disposed between the movable assembly and the longitudinal bore.

20. A tap for a gas or liquefied gas cylinder comprising a tap body, a tap stem-closure element assembly movable between a closed position and an open position, and an annular element joined to the tap stem for rotation therewith and disposed exteriorly of the tap body, and an external ring disposed about the tap body and retained against rotation with respect thereto, said ring being mounted by a helical engagement means on the exterior of the annular element so that the ring effectuates an axial telescoping motion with respect to the annular element and the tap body in response to rotational movement of the tap stem and the annular element to cover or uncover a means for signaling the open position or the closed position of the tap.

21. The tap according to claim 20, wherein the indicating means is fixed stationary with respect to the tap body.

22. The tap according to claim 20, wherein the helical engagement means is an internal thread of the ring and an external thread of the annular element.

23. The tap according to claim 22, wherein the tap stem-closure element assembly is provided with an external thread in engagement with an internal thread formed in the interior of the tap body, and wherein the engaged threads of the ring and the annular element have a higher pitch than the engaged threads of the tap body and the tap stem-closure element assembly.

24. The tap according of claim 20, wherein the external surface of the tap body is provided with an hexagonal shape engaged by an internal portion of corresponding shape of said ring.

25. The tap according to claim 20, wherein the signaling means is provided on the external surface of the tap body, said signaling surface having a different color than adjoining parts of the tap and being concealed by the ring in the open position of the tap and exposed by the axial motion of the ring when the tap stem is rotated in the direction to close the tap.

26. The tap according to claim 20, wherein the signaling means is formed by the annular element joined to the tap stem for rotation therewith, said annular element having a different color than adjoining parts of the tap and being concealed by the ring in the closed position of the tap and partly exposed by the axial movement of the ring when the tap stem is rotated in a direction to open the tap.

27. The tap according to claim 20, wherein an actuating wheel is fixed to the tap stem to rotate the same.

28. The tap according to claim 27, wherein the actuating wheel is a member separate from the annular element joined to the tap stem for rotation therewith, and wherein the tap stem is provided with a weakening zone disposed approximately at the interface between the actuating wheel and the annular element.

29. The tap according to claim 27, wherein the actuating wheel and the annular element are formed of one single piece.
